(19) United States
(12) Patent Application Publication
(10) Pub. No.: US 2004/0075201 A1
(43) Pub. Date: Apr. 22, 2004

(54) Shock-absorber units for use in a vacuum chamber for braking runaway moving objects

(75) Inventors: Yasushi Yoda, Fukaya-shi (JP); Hiroaki Narushima, Sinagawa-ku (JP)

Correspondence Address: KLARQUIST SPARKMAN, LLP, One World Trade Center, Suite 1600, 121 S.W. Salmon Street, Portland, OR, 97204-2988, US

(73) Assignee: Nikon Corporation

(21) Appl. No.: 10/661,311

(22) Filed: Sep. 12, 2003

(30) Foreign Application Priority Data
Sep. 17, 2002 (JP) 2002-269780

(51) Int. Cl. F16M 1/00

(52) U.S. Cl. 267/136

(57) ABSTRACT

Shock-absorber units are disclosed that are especially suitable for use in a vacuum environment. Suitability is manifest by, in the event of damage to or malfunction of the shock-absorber units, their not degrading the vacuum level or contaminating the chamber in which the vacuum is established. An embodiment of a shock-absorber unit is mounted to the inside surface of a wall of the chamber and includes a hydraulic or gas cylinder that is sealed from the chamber by a sheath (e.g., a bellows and/or sealing base). For example, the shock-absorber units are effective for braking the momentum of a runaway stage or other massive, moving object in the chamber.

### FIELD

This disclosure pertains to vacuum chambers containing a moving body that can exhibit a motion (e.g., a runaway motion) requiring arrestment using a “shock-absorber unit.” An exemplary vacuum chamber in this regard is associated with certain microlithography systems, in which the vacuum chamber contains a moving stage or analogous massive device for holding an object, such as a pattern-defining reticle or lithographic substrate, that must be operated in a vacuum environment while being protected from contamination. This disclosure also pertains to shock-absorber units that are especially suitable for use in a vacuum chamber of a microlithography system because the shock-absorber units, during use or during an incident involving malfunction or damage to the shock-absorber units, do not degrade the vacuum level or contaminate the interior of the vacuum chamber.

### BACKGROUND

In a modern projection-microlithography system, a pattern-defining reticle and a lithographic substrate are placed on respective stages, with which the reticle and substrate can be positioned highly accurately relative to each other for making lithographic exposures. These stages, especially the substrate stage, are massive devices that, when actuated, move very rapidly (including rapid accelerations and decelerations). As a precaution in view of the masses of these stages, respective shock absorbers typically are associated with them for arresting uncontrolled and/or excessive motions (collectively termed “runaway” motions) of the stages, such as could occur if the feedback-control of the stage motion were to malfunction. For such a purpose, the shock absorber normally is placed at or near a range limit of stage motion.

Conventional shock absorbers used for the purpose summarized above are similar in certain aspects to automotive shock absorbers, which are of the “oil-damper” type. An oil-damper shock absorber includes a hydraulic cylinder filled with hydraulic oil and includes a hydraulic piston to which is connected a piston rod that can extend and retract relative to the cylinder. The cylinder normally is affixed to a rigid, unyielding surface and the moving body (e.g., stage) is configured to contact and displace the piston rod relative to the cylinder at least during times in which shock absorption is indicated, such as during a runaway condition of the moving body. The hydraulic cylinder includes one or more orifices (e.g., extending through the piston) that limit the rate at which the oil passes through the orifice(s). Oil flow through the orifice(s) is urged whenever the piston moves relative to the cylinder. The resistance to flow of the oil under such conditions provides the shock absorption, and hence arrestment of the moving body.

Conventional oil-damper shock absorbers, while generally remaining intact during normal use, tend to release small amounts of hydraulic oil over time. For example, a dynamic seal normally exists between the piston rod and the hydraulic cylinder containing the oil. Whereas the seal normally prevents release of large amounts of hydraulic oil from the cylinder, a small amount of oil inevitably remains on the surface of the piston rod outside the cylinder. Under vacuum conditions, this oil tends to volatilize. If the seal fails or if the cylinder integrity is compromised, then a substantial amount of hydraulic oil could be released from the cylinder. If the shock absorber is used in a “vacuum” (subatmospheric-pressure) environment such as in a vacuum chamber, any release of hydraulic oil from the cylinder can be especially troublesome because the released oil is volatilized and can condense or otherwise become deposited on various components in the chamber.

Most contemporary microlithography still is performed using “optical” microlithography systems employing deep-ultraviolet (deep-UV) light. Since deep-UV light is not attenuated by propagation through air, optical microlithography need not be performed in a vacuum environment. As a result, conventional oil-damper shock absorbers can be used in connection with the stages in an optical microlithography system without being concerned about contaminating a vacuum environment.

Due to limitations in the pattern-transfer resolution obtainable with optical microlithography, recent years have witnessed substantial effort to develop a practical “next generation” lithography (NGL) system capable of achieving finer pattern-transfer resolution (e.g., 0.1 μm or less) than obtainable using optical microlithography. The two principal NGL approaches are charged-particle-beam (CPB) microlithography and “soft X-ray” (also termed “extreme ultraviolet” or “EUV”) microlithography, both of which must be performed in a vacuum environment. Specifically, for example, the pattern-defining reticle and lithographic substrate (e.g., resist-coated semiconductor wafer) are disposed inside a vacuum chamber (or in separate respective vacuum chambers) that are exhausted to a desired high-vacuum level. Present trends indicate that one or both these NGL approaches will become the successor “workhorse” microlithography technology to optical microlithography in the near future.

Even with stages situated inside a vacuum chamber, it still is desirable to provide the stages with shock-absorber units, especially for arresting runaway movements of the stages, should such movements occur. But, for reasons as summarized above, conventional oil-damper shock absorbers are not suitable for use in high-vacuum chambers because of their tendency to release oil, especially over time and/or if the shock absorber becomes damaged or malfunctions. For example, the oil released from a damaged or failed shock absorber can cause catastrophic damage to the vacuum chamber and to any components and structures situated inside the vacuum chamber.

### SUMMARY

The shortcomings of conventional devices as summarized above are cured by the present invention that provides, inter alia and according to first aspect of the invention, shock-absorber units for arresting motion of a moving mass in a vacuum environment. These shock-absorber units advantageously do not degrade the vacuum environment even if, by chance, damage or malfunction arises with the shock-absorber unit. An embodiment of the shock-absorber unit comprises a shock absorber and an isolation means. The shock absorber has a proximal end and a distal end. The distal end extends toward the mass so as to be contacted by the mass moving with a momentum directed toward the shock absorber. The shock absorber is configured to absorb the momentum and thus arrest motion of the mass as the mass, moving toward the shock absorber, makes contact with the distal end. The isolation means serves to isolate the shock absorber from the vacuum environment.

Desirably, especially if the vacuum environment is established in a vacuum chamber, the proximal end of the shock absorber is affixed to a wall of the vacuum chamber. As an example of this configuration, if the wall of the vacuum chamber defines a through-hole, then the proximal end of the shock absorber can extend through the through-hole to the inside of the vacuum chamber from outside the vacuum chamber.

The distal end of the shock absorber can be configured to exhibit movement in a motion direction of the mass whenever the shock absorber is absorbing the momentum of the mass. In this configuration the isolation means moves with the distal end of the shock absorber whenever the shock absorber is absorbing the momentum of the mass. For example, the isolation means can comprise a bellows that is axially arranged and that exhibits compression in the motion direction accompanying a corresponding motion of the distal end. The bellows can be attached in a sealing manner to the shock absorber to isolate at least a portion of the shock absorber, including the distal end, from the vacuum environment. The bellows can have a distal end contacted by the distal end of the shock absorber, and further can comprise an extension-limitation means, connected to the distal end of the bellows, that serves to impose a maximum allowable extension of the distal end of the shock absorber.

The isolation means can be configured to cover, within an interior space defined by the isolation means, at least a portion of the shock absorber including the distal end. In this configuration the interior space is in communication with an atmosphere external to the vacuum environment. If the atmosphere external to the vacuum environment has a subatmospheric pressure, then the shock-absorber unit further can comprise an exhaust pump, fluidically connected to the interior space, that establishes the subatmospheric pressure.

The isolation means can be configured to cover, within an interior space defined by the isolation means, at least a portion of the shock absorber including the distal end. In this configuration the interior space can be at a vacuum level substantially the same as the vacuum level in the vacuum environment.

The shock-absorber unit further can comprise extension-limitation means (e.g., cables or the like) connected to the distal end and serving to impose a maximum allowable extension of the distal end.

The distal end can comprise a movable shaft having an outside diameter and axially extending toward the mass. In this configuration the isolation means can comprise a stationary head cover providing a dynamic seal to the shaft and isolating at least a portion of the shock absorber from the vacuum environment.

The shock absorber desirably contains a liquid that facilitates shock absorption by the shock absorber. In this configuration the isolation means desirably comprises a sheath forming a seal preventing entry of the liquid, that has escaped from the shock absorber, into the vacuum environment. For example, the liquid is a vacuum oil having a very low vapor pressure. The shock absorber can comprise a hydraulic cylinder for containing the oil. The hydraulic cylinder can include: (a) a housing containing the oil and having a distal end and a proximal end, wherein the proximal end is located at the proximal end of the shock absorber, and (b) a piston rod extending from inside the housing through a dynamic seal in the housing to the distal end of the shock absorber. In this configuration the sheath can comprise a bellows having a proximal end sealingly attached to the housing and a closed distal end to which a distal end of the piston rod, situated inside the bellows, extends and contacts. This configuration further can comprise means for maintaining contact of the distal end of the piston rod with the closed distal end of the bellows. The means for maintaining contact can comprise a spring urging movement of the piston rod relative to the housing. The distal end of the bellows can be attached in a sealed manner to a disk having an inside surface contacted by the distal end of the piston rod and an outside surface to which a bumper is mounted, wherein the bumper is contactable by the movable mass moving toward the bumper.

The shock-absorber unit further can comprise a fixed base, to which the proximal end of the shock absorber is mounted, and a contact member contacted by the distal end of the shock absorber. The contact member in this configuration is situated and configured to be contacted by the mass moving toward the shock absorber. The isolation means in this configuration can comprise a sheath extending between the fixed base and the contact member. This configuration further can comprise a compression-limitation means extending between the fixed base and the contact member, wherein the extension-limitation means imposes a maximum allowable distance of the contact member from the fixed base.

Another embodiment of a shock-absorber unit comprises a shock absorber including (a) a gas-filled portion, (b) a piston situated and movable within the gas-filled portion and separating the gas-filled portion from a non-gas-filled portion, and (c) a piston rod extending from the piston through the non-gas-filled portion to outside the gas-filled and non-gas-filled portions and toward the mass so as to be contacted by the mass moving with a momentum toward the shock absorber. With this configuration contact of the mass with the piston rod causes movement of the piston and a consequent reduction in volume of the gas-filled portion. The gas-filled portion and the non-gas-filled portion desirably are respective portions of a gas cylinder having an axis parallel to a momentum direction of the mass. This embodiment further can comprise a vent space, a conduit connecting the vent space to the gas-filled portion, and a flow-restrictor situated in the conduit and configured to restrict a flow rate of gas from the gas-filled portion to the vent space whenever movement of the piston is reducing the volume of the gas-filled portion. If the vacuum environment is established in a vacuum chamber, the vent space desirably is located outside the vacuum chamber.

Yet another embodiment of a shock-absorber unit comprises (a) a contact portion situated and configured to contact the moving mass as the mass moves with a momentum in a movement direction toward the contact portion, (b) a movement guide situated relative to the contact portion and configured to guide movement of the contact portion as the shock-absorber unit absorbs the momentum of the mass, and (c) a compliant member situated between the contact portion and a rigid stop and configured to exhibit a compliant deformation, in response to the mass contacting the contact portion, that provides resistance to the motion of the contacting mass. The compliant member can comprise a compliant rod having an axis oriented parallel to the movement direction of the mass. The compliant member further can comprise a compression spring urging restoration of a pre-impact length of the compliant rod, relative to the rigid stop. The contact portion and compliant member can be situated and configured to move, when the moving mass contacts the contact portion, in a direction parallel to the direction of the momentum of the moving mass. The compliant member can be made of an elastomer such as a fluororesin, a polyimide, or a polyether ether ketone.

A shock-absorber unit according to yet another embodiment comprises a hydraulic cylinder having a housing and a piston rod. The piston rod has a distal end situated and configured to receive an impact of the mass moving in a movement direction, and the hydraulic cylinder contains a low-vapor-pressure oil used to arrest the movement of the mass.

According to another aspect of the invention, various embodiments of vacuum chambers are provided. The various embodiments include a vessel having walls collectively defining an interior space of the vacuum chamber, and a movable mass contained within the vacuum chamber. The various embodiments also include a respective one or more of any of the shock-absorber units summarized above.

According to another aspect of the invention, microlithography systems are provided. The various embodiments include a vacuum chamber establishing a vacuum environment for performing microlithography, and a movable stage contained within the vacuum chamber. The various embodiments also include a respective one or more of any of the shock-absorber units summarized above. The embodiments also include a respective one or more of any of the shock-absorber units summarized above. In any of these embodiments the stage can be, e.g., a reticle stage or a substrate stage.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic elevational diagram generally depicting overall structures and imaging relationships in an embodiment of an electron-beam microlithography system, as an exemplary microlithography system, that includes at least one shock-absorber unit as disclosed herein.

FIG. 2 is an elevational view (with partial section) of a shock-absorber unit, according to a first representative embodiment, in a fully extended state.

FIG. 3 is an elevational view (with partial section) of the shock-absorber unit of FIG. 2 is a fully retracted state.

FIG. 4 is a schematic, partially oblique view of a shock-absorber unit according to a second representative embodiment.

FIG. 5 is a schematic, partially oblique view of a shock-absorber unit according to a third representative embodiment.

FIG. 6 is an elevational view (and partial section) of a shock-absorber unit according to a fourth representative embodiment.

FIG. 7 is an elevational view (and partial section) of a shock-absorber unit according to a fifth representative embodiment.

FIG. 8 is an elevational view (and partial section) of a shock-absorber unit according to a sixth representative embodiment.

FIG. 9 is a schematic, partially oblique view of a shock-absorber unit according to a seventh representative embodiment.

### DETAILED DESCRIPTION

The invention is described in the context of multiple representative embodiments that are not intended to be limiting in any way.

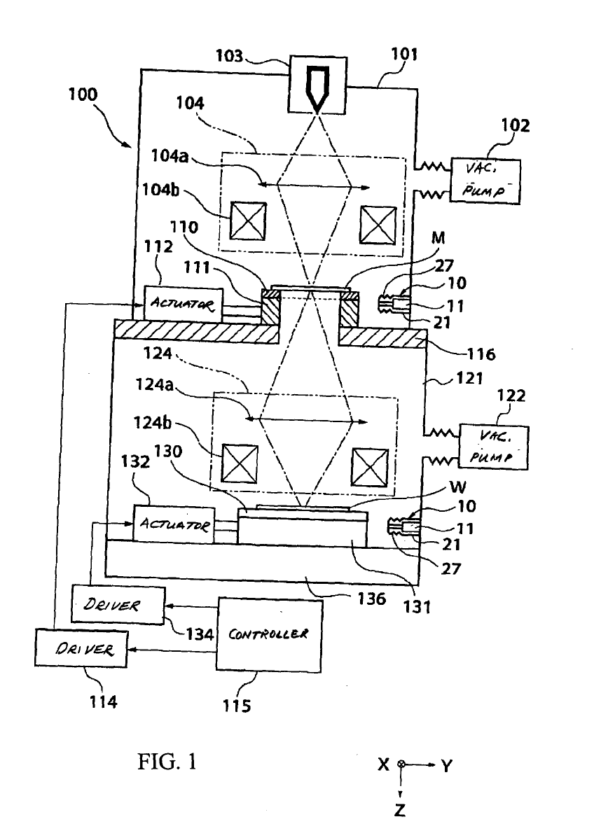

First, the overall structure of an exemplary microlithography system is described with reference to FIG. 1, in which the depicted microlithography system 100 utilizes an electron beam as an energy beam and comprises at least one shock-absorber unit as described later below.

The system 100 includes an optical column 101 situated at the upstream end of the system. The optical column 101 is configured as a vacuum chamber having an interior space that is evacuated to a desired vacuum level using a vacuum pump 102 connected via a vacuum conduit to the optical column 101.

At the extreme upstream end of the optical column 101 is an electron gun 103 that emits an electron beam propagating in a downstream direction (downward in the figure). The electron beam, termed an “illumination beam,” passes through an illumination-optical system 104 contained within the optical column 101 downstream of the electron gun 103. The illumination-optical system 104 comprises a condenser lens 104a, an electron-beam deflector 104b, and other components as required to trim, configure, and position the beam for illumination of a desired region of the reticle R situated downstream of the illumination-optical system 104. Specifically, the electron beam emitted from the electron gun 103 is condensed by the condenser lens 104a. The deflector 104b scans (sweeps) the illumination beam in the X- and/or Y-direction to illuminate, in a sequential manner, individual subfields of the reticle R located within the optical field of the illumination-optical system 104. For simplicity, only one condenser lens 104a is shown. Typically, the illumination-optical system 104 comprises multiple condenser lenses (i.e., two or more lens “stages”), as well as a beam-shaping diaphragm, a blanking diaphragm, and other components as required to achieve a desired condition of reticle illumination.

For exposure, the reticle is placed on a reticle stage 111, on which the reticle is held by electrostatic attraction or other suitable means on an upstream-facing surface of a reticle chuck 110 mounted to the reticle stage 111. The reticle stage 111 is mounted on a platform 116 or analogous rigid support. The reticle stage 111 is moved by a reticle-stage actuator 112. Although the reticle-stage actuator 112 is shown at left in the figure, it typically is a linear motor or other suitable actuator that is integrated into the reticle stage 111. The reticle-stage actuator 112 is connected to a controller 115 via a reticle-stage driver 114. A laser interferometer (not shown) is used for determining the position of the reticle stage 111. The laser interferometer also is connected to the controller 115. Thus, accurate positional data concerning the reticle stage 111, as measured by the laser interferometer, are input to the controller 115, which (in response to the positional data) generates and routes commands to the reticle-stage driver 114 to energize the reticle-stage actuator 112 as required to position the reticle stage 111 at a target position. Thus, the position of the reticle stage 111 is controlled accurately in real time.

A wafer chamber 121 (a second vacuum chamber) is situated downstream of the platform 116. The interior of the wafer chamber is evacuated to a desired vacuum level by a vacuum pump 122. The wafer chamber 121 contains a projection-optical system 124 (configured as a respective optical column) that includes a projection lens 124a, a deflector 124b, and other components as required. Downstream of the projection-optical system 124 is an exposure-sensitive substrate W (typically a resist-coated semiconductor wafer).

The electron beam that has passed through the reticle R is condensed by the projection lens 124a and deflected by the deflector 124b as required to form an image of the illuminated portion of the reticle R on a prescribed location on the surface of the substrate W. Even though only one projection lens 124a is shown in the figure, the projection-optical system 124 typically includes at least two projection lenses as well as aberration-correction lenses and deflector coils as required.

The substrate W is held (by electrostatic attraction or other suitable force) by a wafer chuck 130 mounted to the upstream-facing surface of a wafer stage 131. The wafer stage 131 is mounted on a platform 136 or other rigid support. The wafer stage 131 is moved by a wafer-stage actuator 132. Although the wafer-stage actuator 132 is shown at left in the figure, it typically is a linear motor or other suitable actuator that is integrated into the wafer stage 131. The wafer-stage actuator 132 is connected to the controller 115 via a wafer-stage driver 134. A laser interferometer (not shown) is used for determining the position of the wafer stage 131. The laser interferometer also is connected to the controller 115. Thus, accurate positional data concerning the wafer stage 131, as measured by the laser interferometer, are input to the controller 115, which (in response to the positional data) generates and routes commands to the wafer-stage driver 134 to energize the wafer-stage actuator 132 as required to position the wafer stage 131 at a target position. Thus, the position of the wafer stage 131 is controlled accurately in real time.

The microlithography system 100 includes a first shock-absorber unit 10 attached to the wall of the optical column 101 to the right (in the figure) of the reticle stage 111. Similarly, a second shock-absorber unit 10 is attached to the wall of the wafer chamber 121 to the right (in the figure) of the substrate stage 131. The shock-absorber units 10 arrest motion of the respective stages 111, 131 whenever the respective stages are in a runaway condition, for example. In order for a shock-absorber unit 10 to provide the respective arrestment, the respective stage must move sufficiently (to the right in the figure) to contact the respective shock-absorber unit 10.

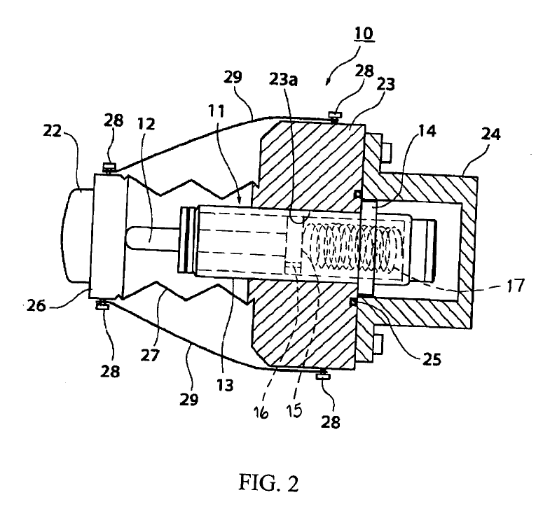

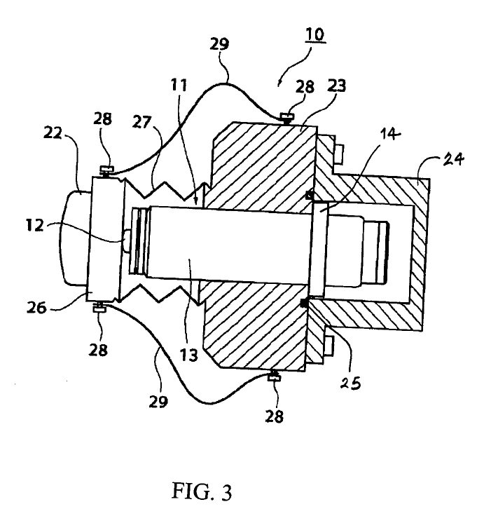

Details of a first representative embodiment of a shock-absorber unit 10 are shown in FIGS. 2 and 3, showing the shock-absorber unit 10 in a fully extended and fully retracted condition, respectively. In FIGS. 2 and 3 the left side of the depicted unit is the distal end, and the right side is the proximal (rear) end. The shock-absorber unit 10 comprises a hydraulic cylinder 11, a bellows 27 that seals the distal end of the hydraulic cylinder 11, and a base 23 used for attaching the shock-absorber unit 10 (specifically the proximal end of the hydraulic cylinder 11) to an unyielding support such at the wall of a vacuum chamber (not shown). The hydraulic cylinder 11 comprises a housing 13 (e.g., cylindrical in shape) filled with hydraulic oil. At the proximal end of the housing 13 is a flange 14 projecting radially outward as a rim from the housing 13. The housing 13 contains a piston rod 12 that extends outward (to the left in the figure) from the housing 13. The piston rod 12 is connected inside the housing 13 to a piston 15. As in conventional hydraulic shock absorbers, the piston 15 defines at least one orifice 16 through which hydraulic oil is urged whenever the piston is moving inside and relative to the housing 13.

When not under load the piston 15 is urged to move in the extension direction (leftward in FIG. 2) in response to a force applied to the piston by a spring 17 or analogous component. In other words, whenever no external load is being applied to the distal end of the piston rod 12, the piston rod 12 exhibits maximal extension, as shown in FIG. 2.

If the respective stage is in a runaway condition moving to the right in FIG. 2, the stage eventually contacts the distal end of the shock-absorber unit 10. As the shock-absorber unit 10 absorbs the momentum of the moving stage, the piston rod 12 is pushed into (rightward in the figure) the housing 13. The resulting urging of hydraulic fluid through the at least one orifice 16 in the piston 15 yields the requisite arrestment of stage motion. In other words, contact of a runaway stage with the distal end of the shock-absorber unit 10 causes the piston 15 to move to the right in the figure against the force applied to the piston by the spring 17 and against the fluid resistance of the oil being displaced forcibly through the orifice 16, thereby arresting the movement of the stage.

The hydraulic oil used in the housing 13 desirably is a vacuum oil having a very low vapor pressure. Use of vacuum oil reduces the risk of damage to nearby components in case the cylinder 11 releases any oil.

The base 23 extends circumferentially around the proximal end of the housing 13. Extending distally from the base 23 is the bellows 27 that sealingly covers both the distal end of the cylinder 11 and the distal end of the piston rod 12. The distal end of the piston rod 12 contacts a disk 26, wherein the disk is affixed circumferentially to the distal end of the bellows 27 in a sealing (gas-tight) manner. Extending distally (to the left in the figure) from the disk 26 is a bumper 22 made of a compliant material (e.g., Teflon®). The base 23, bellows 27, and disk 26 collectively constitute a “sheath” that isolates the hydraulic cylinder 11 from the vacuum environment in which the shock-absorber unit 10 is used (e.g., inside the optical column 101 or inside the wafer chamber 121).

The base 23 defines a through-hole 23a through which the housing 13 extends. Near its proximal end the housing 13 defines the flange 14 up to which the housing 13 extends through the through-hole 23a. Thus, during use of the shock-absorber unit 10 the flange 14 is situated snugly against the “rear” surface of the base 23.

Fastened to the base 23 (by, e.g., machine screws or analogous fasteners) is a “bottom” cover 24 that sealingly covers the proximal end of the housing 13 extending rearward from the base 23. The seal is provided by an O-ring 25 sandwiched between the base 23 and the bottom cover 24. Thus, the proximal end of the housing 13 is sealed from the exterior environment, and the vacuum level in the vacuum chamber is not compromised by the through-hole 23a.

Whenever a runaway stage contacts the shock-absorber unit 10, the bumper 22 receives the sudden impact. The compliance of the bumper 22 prevents damage to the shock-absorber unit 10 and/or to the stage that otherwise could be caused by rapid stage deceleration, and allows the shock-absorber unit 10 to perform its intended arrestment of stage motion.

Attachment of the bellows 27 in a gas-tight manner to the base 23 and to the disk 26 can be achieved by, e.g., welding to an appropriately configured shoulder on the base 23 and to the peripheral-side surface of the disk 26. Thus, the bellows 27 expands and contracts with corresponding motions of the piston rod 12 relative to the cylinder 11. As shown in FIG. 3, whenever a runaway stage contacts the bumper 22 with sufficient force to cause retraction of the piston rod 12 relative to the cylinder 11, the bellows 27 exhibits a contraction that corresponds to the magnitude of retraction.

Multiple (at least two) wires 29 or analogous extension limiters extend lengthwise between the base 23 and the disk 26 outside the bellows 27. First ends of the wires 29 are affixed to pins 28 inserted into the peripheral-side surface of the base 23, and second ends of the wires 29 are affixed to pins 28 inserted into the peripheral-side surface of the disk 26. Whenever the piston rod 12 is under no load and is at fully allowable extension (FIG. 2), the wires 29 are taught, which ensures that the “rear” surface of the disk 26 remains in contact with the distal tip of the piston rod 12 (urged into full extension by the spring 17). Creation of a vacuum inside the optical column 101 or wafer chamber 121 favors the bellows 27 being at full extension (except under load) because of the difference in pressure of the atmosphere inside the vacuum chamber versus the pressure inside the bellows 27. The wires 29 limit the maximal extension of the piston rod and thus of the disk 26 and bumper 22 relative to the housing 13.

Thus, in this embodiment the hydraulic cylinder 11 is housed inside the sheath comprising the bellows 27 and thus is isolated from the vacuum environment inside the optical column 101 and vacuum chamber 121. Any oil released from the shock-absorber unit 10 (e.g., from damage or malfunction during use) is prevented by the sheath from entering the vacuum chamber, thereby avoiding contamination of the interior of the vacuum chamber or degradation of the degree of vacuum established in the chamber.

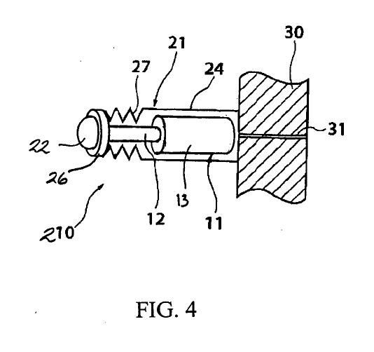

A second representative embodiment of a shock-absorber unit 210 is shown in FIG. 4, in which components that are similar to corresponding components in FIGS. 2-3 have the same respective reference numerals and are not described further. In FIG. 4 the shock-absorber unit 210 is attached to a chamber wall 30 of the optical column 101 or wafer chamber 121 (see FIG. 1). Specifically, the shock-absorber unit 210 comprises a hydraulic cylinder 11 including a housing 13 and a piston rod 12. The hydraulic cylinder 11 is mounted to the chamber wall 30. The bottom cover 24 in this embodiment extends from the surface of the chamber wall 30 lengthwise along the housing 13. A bellows 27 extends between the distal end of the bottom cover 24 and the disk 26 that contacts the distal end of the piston rod 12. The bellows 27, disk 26, and bottom cover 24 collectively constitute a “sheath.” The disk 26 includes a bumper 22 as described previously. A through-hole 31 is defined in the chamber wall 30 and extends between and allows communication between the exterior of the chamber wall 30 with the interior of the sheath. Thus, via the through-hole 31, the interior of the sheath is in communication with the atmosphere external to the vacuum chamber, not with the atmosphere inside the vacuum chamber.

Inside the vacuum chamber defined by the walls 30, whenever a runaway stage contacts the bumper 22, the piston rod 12 is urged by the momentum of the stage to retract into the housing 13 of the hydraulic cylinder 11, thereby arresting the stage motion. As the bumper 22 and disk 26 move to the right in the figure, the volume inside the sheath decreases, forcing air inside the sheath to escape through the through-hole 31 to the external environment. This ventilation of the atmosphere inside the sheath avoids a pressure increase inside the sheath that otherwise could generate a counter-force urging stage movement in the opposite direction.

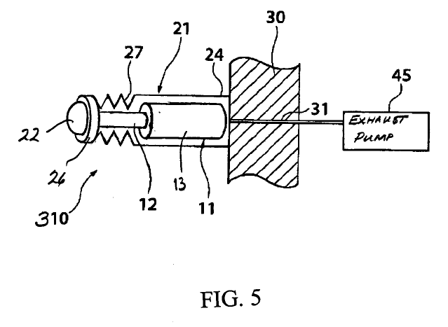

A third representative embodiment of a shock-absorber unit 310 is shown in FIG. 5, in which components that are similar to corresponding components in FIG. 4 have the same respective reference numerals and are not described further. The shock-absorber unit 310, attached to a chamber wall 30 of the optical column 101 or wafer chamber 121 in the same manner as the embodiment of FIG. 4, is similar to the shock-absorber unit 210 of FIG. 4 except for the addition of an exhaust pump 45 connected to the through-hole 31 in the chamber wall 30. The exhaust pump 45 is situated outside the chamber wall 30 and operates to create, via the through-hole 31, a subatmospheric pressure (“vacuum”) inside the sheath. The exhaust pump 45 desirably creates the vacuum in the sheath at the same time, for example, the vacuum pumps 102, 122 create the respective vacuum levels in the optical column 101 and wafer chamber 121, respectively. Thus, the vacuum level established inside the sheath (e.g., inside the bellows 27) can be at or near the vacuum level inside the vacuum chamber defined by the walls 30, which prevents a sharp pressure increase inside the sheath whenever a runaway stage impacts the shock-absorber unit 310. Preventing a pressure increase inside the sheath results in a smooth absorption by the shock-absorber unit 310 of the impact of the runaway stage.

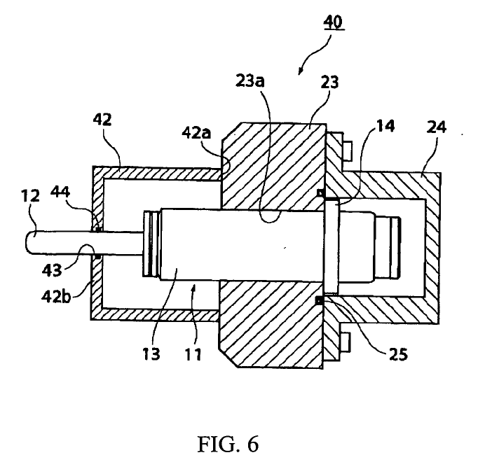

A fourth representative embodiment of a shock-absorber unit 40 is shown in FIG. 6, in which components that are similar to corresponding components in FIGS. 2 and 3 have the same respective reference numerals and are not described further. The shock-absorber unit 40 comprises a hydraulic cylinder 11, piston rod 12, housing 13, base 23, flange 14, bottom cover 24, and O-ring 25, all similar to corresponding features in the embodiment of FIGS. 2 and 3. The shock-absorber unit 40 also comprises a cylindrical head cover 42 covering the distal end of the housing 13. The end surface 42a of the head cover 42 is affixed (e.g., welded) to the front surface of the base 23. The distal end of the head cover 42 includes a wall 42b defining a central through-hole 43 through which the distal end of the piston rod 12 axially extends. The clearance between the through-hole 43 and the diameter of the piston rod 12 is sufficient to allow the piston rod to slide axially relative to the head cover 42. To form a sliding seal between the piston rod and the head cover 42, an O-ring 44 is inserted in a gland defined in the inside diameter of the through-hole 43. The O-ring 44, while preserving a gas-tight seal between the piston rod 12 and the wall 42b, allows the piston rod to slide axially relative to the wall 42b without significant resistance. The seal can be enhanced, if required, by application of a suitable vacuum grease (having a very low vapor pressure) to the O-ring 44. As an alternative to using the O-ring 43, a seal between the piston rod 12 and wall 42b can be achieved using a magnetic fluid, for example.

Thus, the distal end of the piston rod 12 extends from the head cover 42 toward the stage with which the shock-absorber unit 40 is used. A runaway stage contacts the distal end of the piston rod 12 and causes retraction of the piston rod into the housing 13, which absorbs the momentum of the stage, as described previously, thereby arresting stage motion. If desired or required, a suitable vacuum level can be established inside the space defined by the head cover 42 and base 23, in the manner as described in the third representative embodiment. In any event, the hydraulic cylinder 11 of this shock-absorber unit 40 is effectively isolated from the interior of the vacuum chamber in which the shock-absorber unit is installed. This isolation is especially important, as described earlier, for protecting the vacuum chamber from oil released from the housing 13 in the event of damage to or malfunction of the hydraulic cylinder 11.

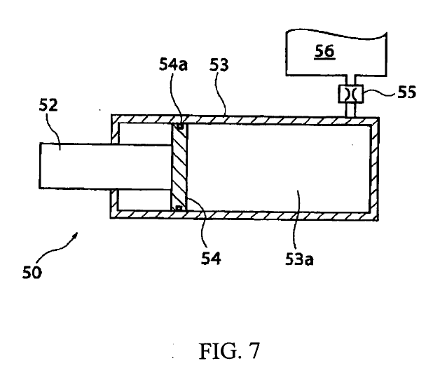

A fifth representative embodiment of a shock-absorber unit 50 is shown in FIG. 7. The shock-absorber unit 50 comprises a gas cylinder 53 that defines an interior space 53a filled with an appropriate gas. The interior space 53a is in communication, via an orifice 55, with a vent space 56. In this embodiment, although the interior space 53a and vent space 56 are separate from each other, it alternatively is possible to house both the interior space 53a and the vent space 56 inside the gas cylinder 53. Alternatively, the vent space 56 can be situated outside the vacuum chamber.

The gas cylinder 53 comprises a piston 54 that can move in a reciprocating manner (left and right in the figure) within the interior space 53a. The piston includes a circumferential side surface defining a gland in which an O-ring 54a is installed. The O-ring 54a forms a sliding (but nevertheless gas-tight) seal between the piston 54 and the inside diameter of the gas cylinder 53. A piston rod 52 is attached to the piston 54.

The shock-absorber unit 50 is installed (e.g., on the inside wall of a vacuum chamber, not shown) such that a runaway stage in the vacuum chamber collides with the distal end of the piston rod 52. The momentum of the stage causes the piston rod 52 (and piston 54) to move to the right in the figure, which reduces the volume of the gas-filled interior space 53a. The resulting compression increases the pressure of gas in the interior space 53a, which urges a strong flow of gas from the interior space 53a through the orifice 55 into the vent space 56. The resistance to gas flow imparted by the orifice 55 arrests the motion of the runaway stage.

Removal of the load from the piston rod 52 allows residual gas pressure in the interior space 53a to move the piston 54 to the left in the figure (this motion additionally can be urged by a spring situated inside the gas cylinder 53). The resulting increased volume of the interior space 53a causes a reversed gas flow from the vent space 56 into the interior space 53a, thereby restoring the shock-absorber unit 50 to a “ready” status. With this embodiment, even if the gas cylinder 53 is damaged or malfunctions sufficiently to allow leakage of gas therefrom, the vacuum chamber (e.g., optical column 101 or wafer chamber 121) in which the shock-absorber unit 50 is installed is undamaged; the only corrective measure required is restoration of the desired vacuum level in the chamber. No cleaning of oil from the chamber is required.

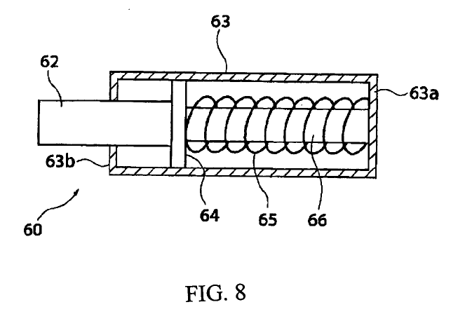

A sixth representative embodiment of a shock-absorber unit 60 is shown in FIG. 8. The shock-absorber unit 60 comprises a cylinder 63 containing a disk-shaped partition (piston) 64 that is movable in a reciprocating manner along the axis of the cylinder 63 (i.e., left and right in the figure). The piston 64 is connected to a rigid piston rod 62 having a distal end that extends outside the cylinder 63 through an axial aperture in a distal-end plate 63b of the cylinder 63. The distal end of the piston rod 62 (i.e., the left-hand end) serves as the runaway-stage-contact surface. The piston 64 also is connected to a compliant rod 66 situated inside the cylinder 63 between the proximal-end plate 63a and the piston 64. A compression spring 65 surrounds the compliant rod 66 and is situated between the piston 64 and the proximal-end plate 63a. The proximal-end plate 63a is mounted to the inside surface of a wall (not shown) of a vacuum chamber.

Whenever a runaway stage in the vacuum chamber encounters the distal end of the piston rod 62, the resulting impact causes the piston rod 62 and piston 64 to move to the right in the figure, relative to the cylinder 63. Meanwhile, as urged by the piston rod 62, the compliant rod 66 compresses lengthwise and the coil spring 65 becomes more compressed, thereby generating a counter-force directed to the left in the figure.

The compliant rod 66 can be made of an elastomeric material such as a fluororesin, a polyimide, or polyether ether ketone, etc. Note that the interior of the cylinder 63 is not gas-tight; gas can flow past the piston 64 and can exit the cylinder 63 through the opening defined in the distal-end plate 63b for the piston rod 62. Consequently, as the atmosphere in the chamber in which the shock-absorber unit 60 is located is evacuated, the interior of the cylinder 63 also is evacuated.

Although FIG. 8 depicts both the coil spring 65 and the compliant rod 66 being used inside the cylinder 63, either the spring 65 or rod 66 can be eliminated, depending upon the actual conditions under which the shock-absorber unit 60 is used.

The shock-absorber unit 60 of this embodiment functions similarly to the shock-absorber unit 50 of the fifth representative embodiment. I.e., as a runaway stage contacts the distal end of the piston rod 62, the momentum of the moving stage is absorbed by the coil spring 65 and by the compliant rod 66, thereby arresting the stage motion. Subsequently, as the arrested motion reduces the load on the piston rod 62, the compressed coil spring 65 and compliant rod 66 are allowed to relax and recover their respective abilities to absorb further “shock.” The shock-absorber unit 60 advantageously does not pose any risk of oil or gas leakage into the vacuum chamber in which the unit is used.

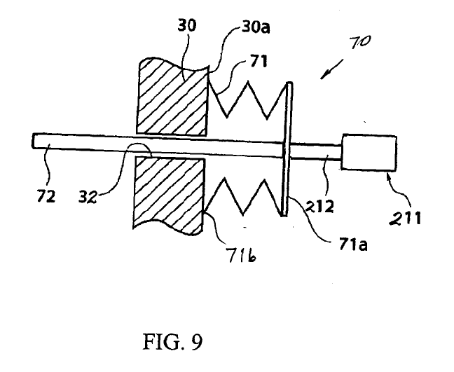

A seventh representative embodiment of a shock-absorber unit 70 is depicted in FIG. 9. The unit comprises a bellows 71 mounted to the exterior surface 30a of a wall 30 of a vacuum chamber such as an optical column 101 or wafer chamber 121 (FIG. 1). The wall 30 defines a through-hole 32, through which a shaft 72 extends into the interior of the vacuum chamber. Thus, the shaft 72 is slidable along its axis (left and right in the figure) relative to the through-hole 32. The bellows 71 includes a proximal end 71b (left-hand end in the figure) attached to the exterior surface 30a in a sealed manner (e.g., the proximal end 71b is welded to the exterior surface 30a). The distal end (right-hand end in the figure) of the bellows 71 includes a closed-end face 71a. The bellows 71 is free to expand and contract along its axis relative to the exterior surface 30a. The outside diameter of the shaft 72 has a slip fit in the through-hole 32. The proximal end of the piston rod 72 contacts the inside surface of the end face 71a of the bellows 71 from a first direction (i.e., from the left in FIG. 9), while the distal end of the piston rod 72 extends into the chamber toward the stage (not shown). Thus, the bellows 71 creates a gas-tight seal around the through-hole 32. Meanwhile, the outside surface of the end face 71a, coaxially with the shaft 72, contacts the distal end of a piston rod 212 of a hydraulic cylinder 211 (which can have a conventional configuration).

Whenever a runaway stage encounters the distal end of the shaft 72, the piston rod 212 is pushed (rightward in the figure) from contact of the proximal end of the shaft 72 with the end face 71a of the bellows 71. This motion of the shaft 72 is arrested by the hydraulic cylinder 211. As the load on the shaft 72 is thus reduced, the piston rod 212 extends more fully from the cylinder 211 (i.e., moves leftward in the figure) to restore the shock-absorber unit 70 for further functioning. Since the hydraulic cylinder 211 is situated outside and sealed from the vacuum chamber, if the cylinder 211 develops an oil leak, no damage to the inside of the vacuum chamber occurs and there is no adverse effect on the vacuum level established inside the chamber.

Whereas the invention has been described in connection with multiple representative embodiments, the invention is not limited to those embodiments. On the contrary, the invention is intended to encompass all modifications, alternatives, and equivalents as may be included within the spirit and scope of the invention, as defined by the appended claims.

What is claimed is:

1. A shock-absorber unit for arresting motion of a moving mass in a vacuum environment, the shock-absorber unit comprising:
a shock absorber having a proximal end and having a distal end extending toward the mass so as to be contacted by the mass moving with a momentum directed toward the shock absorber, the shock absorber being configured to absorb the momentum and thus arrest motion of the mass as the mass, moving toward the shock absorber, makes contact with the distal end; and
isolation means for isolating the shock absorber from the vacuum environment.

2. The shock-absorber unit of claim 1, wherein:
the vacuum environment is established in a vacuum chamber; and
the proximal end of the shock absorber is affixed to a wall of the vacuum chamber.

3. The shock-absorber unit of claim 2, wherein:
the wall of the vacuum chamber defines a through-hole; and
the proximal end of the shock absorber extends through the through-hole to the inside of the vacuum chamber from outside the vacuum chamber.

4. The shock-absorber unit of claim 1, wherein:
the distal end of the shock absorber is configured to exhibit movement in a motion direction of the mass whenever the shock absorber is absorbing the momentum of the mass; and
the isolation means moves with the distal end of the shock absorber whenever the shock absorber is absorbing the momentum of the mass.

5. The shock-absorber unit of claim 4, wherein the isolation means comprises a bellows that is axially arranged and that exhibits compression in the motion direction accompanying a corresponding motion of the distal end.

6. The shock-absorber unit of claim 5, wherein the bellows is attached in a sealing manner to the shock absorber to isolate at least a portion of the shock absorber, including the distal end, from the vacuum environment.

7. The shock-absorber unit of claim 5, wherein the bellows has a distal end contacted by the distal end of the shock absorber.

8. The shock-absorber unit of claim 7, further comprising extension-limitation means connected to the distal end of the bellows and serving to impose a maximum allowable extension of the distal end of the shock absorber.

9. The shock-absorber unit of claim 4, wherein:
the isolation means covers, within an interior space defined by the isolation means, at least a portion of the shock absorber including the distal end; and
the interior space is in communication with an atmosphere external to the vacuum environment.

10. The shock-absorber unit of claim 9, wherein the atmosphere external to the vacuum environment has a subatmospheric pressure.

11. The shock-absorber unit of claim 10, further comprising an exhaust pump, fluidically connected to the interior space, that establishes the subatmospheric pressure.

12. The shock-absorber unit of claim 4, wherein:
the isolation means covers, within an interior space defined by the isolation means, at least a portion of the shock absorber including the distal end; and
the interior space is at a vacuum level substantially the same as the vacuum level in the vacuum environment.

13. The shock-absorber unit of claim 4, further comprising extension-limitation means connected to the distal end and serving to impose a maximum allowable extension of the distal end.

14. The shock-absorber of claim 4, wherein:
the distal end comprises a movable shaft having an outside diameter and axially extending toward the mass; and
the isolation means comprises a stationary head cover providing a dynamic seal to the shaft and isolating at least a portion of the shock absorber from the vacuum environment.

15. The shock-absorber unit of claim 1, wherein:
the shock absorber contains a liquid that facilitates shock absorption by the shock absorber; and
the isolation means comprises a sheath forming a seal preventing entry of the liquid, that has escaped from the shock absorber, into the vacuum environment.

16. The shock-absorber unit of claim 15, wherein the liquid is a vacuum oil.

17. The shock-absorber unit of claim 15, wherein the shock absorber comprises a hydraulic cylinder, including (i) a housing containing the liquid and having a distal end and a proximal end, the proximal end being located at the proximal end of the shock absorber, and (ii) a piston rod extending from inside the housing through a dynamic seal in the housing to the distal end of the shock absorber.

18. The shock-absorber unit of claim 17, wherein the sheath comprises a bellows having a proximal end sealingly attached to the housing and a closed distal end to which a distal end of the piston rod, situated inside the bellows, extends and contacts.

19. The shock-absorber unit of claim 18, further comprising means for maintaining contact of the distal end of the piston rod with the closed distal end of the bellows.

20. The shock-absorber unit of claim 19, wherein the means for maintaining contact comprises a spring urging movement of the piston rod relative to the housing.

21. The shock-absorber unit of claim 17, wherein the distal end of the bellows is sealingly attached to a disk having an inside surface contacted by the distal end of the piston rod and an outside surface to which a bumper is mounted, the bumper being contactable by the movable mass moving toward the bumper.

22. The shock-absorber unit of claim 21, further comprising extension-limitation means connected to the distal end and serving to impose a maximum allowable extension of the distal end.

23. The shock-absorber unit of claim 22, wherein the extension-limitation means comprises at least one cable connected from the disk to the housing outside the bellows.

24. The shock-absorber unit of claim 1, further comprising:
a fixed base to which the proximal end of the shock absorber is mounted; and
a contact member contacted by the distal end of the shock absorber, the contact member being situated and configured to be contacted by the mass moving toward the shock absorber.

25. The shock-absorber unit of claim 24, wherein the isolation means comprises a sheath extending between the fixed base and the contact member.

26. The shock-absorber unit of claim 25, further comprising a compression-limitation means extending between the fixed base and the contact member, the extension-limitation means imposing a maximum allowable distance of the contact member from the fixed base.

27. A shock-absorber unit for arresting motion of a moving mass in a vacuum environment, the shock-absorber unit comprising a shock absorber including a gas-filled portion and a piston situated and movable within the gas-filled portion and separating the gas-filled portion from a non-gas-filled portion, and a piston rod extending from the piston through the non-gas-filled portion to outside the gas-filled and non-gas-filled portions and toward the mass so as to be contacted by the mass moving with a momentum toward the shock absorber, wherein contact of the mass with the piston rod causes movement of the piston and a consequent reduction in volume of the gas-filled portion.

28. The shock-absorber unit of claim 27, wherein the gas-filled portion and non-gas-filled portion are respective portions of a gas cylinder having an axis parallel to a momentum direction of the mass.

29. The shock-absorber unit of claim 27, further comprising:
a vent space;
a conduit connecting the vent space to the gas-filled portion; and
a flow-restrictor situated in the conduit and configured to restrict a flow rate of gas from the gas-filled portion to the vent space whenever movement of the piston is reducing the volume of the gas-filled portion.

30. The shock-absorber unit of claim 29, wherein:
the vacuum environment is established in a vacuum chamber; and
the vent space is located outside the vacuum chamber.

31. A shock-absorber unit for arresting motion of a moving mass in a vacuum environment, the shock-absorber unit comprising:
a contact portion situated and configured to contact the moving mass as the mass moves with a momentum in a movement direction toward the contact portion;
a movement guide situated relative to the contact portion and configured to guide movement of the contact portion as the shock-absorber unit absorbs the momentum of the mass; and
a compliant member situated between the contact portion and a rigid stop and configured to exhibit a compliant deformation, in response to the mass contacting the contact portion, that provides resistance to the motion of the contacting mass.

32. The shock-absorber unit of claim 31, wherein the compliant member comprises a compliant rod having an axis oriented parallel to the movement direction of the mass.

33. The shock-absorber unit of claim 32, wherein the compliant member further comprises a compression spring urging restoration of a pre-impact length of the compliant rod, relative to the rigid stop.

34. The shock-absorber unit of claim 31, wherein the contact portion and compliant member are situated and configured to move, when the moving mass contacts the contact portion, in a direction parallel to the direction of the momentum of the moving mass.

35. The shock-absorber unit of claim 31, wherein the compliant member is made of an elastomer selected from the group consisting of fluororesins, polyimides, and polyether ether ketones.

36. A shock-absorber unit for arresting motion of a moving mass in a vacuum environment, the shock-absorber unit comprising a hydraulic cylinder having a housing and a piston rod, the piston rod having a distal end situated and configured to receive an impact of the mass moving in a movement direction, the hydraulic cylinder containing a low-vapor-pressure oil used to arrest the movement of the mass.

37. A vacuum chamber, comprising:
a vessel having walls collectively defining an interior space of the vacuum chamber;
a movable mass contained within the vacuum chamber; and
a shock-absorber unit for arresting motion of the mass in the vacuum chamber, the shock-absorber unit comprising (i) a shock absorber having a proximal end coupled to a wall and having a distal end extending toward the mass so as to be contacted by the mass moving with a momentum directed toward the shock absorber, the shock absorber being configured to absorb the momentum and thus arrest motion of the mass as the mass, moving toward the shock absorber, makes contact with the distal end; and (ii) isolation means for isolating the shock absorber from the vacuum environment.

38. A vacuum chamber, comprising:
a vessel having walls collectively defining an interior space of the vacuum chamber;
a movable mass contained within the vacuum chamber; and
a shock-absorber unit coupled to a wall of the vacuum chamber for arresting motion of the mass in the vacuum chamber, the shock-absorber unit comprising (i) a shock absorber including a gas-filled portion, (ii) a piston situated and movable within the gas-filled portion and separating the gas-filled portion from a non-gas-filled portion, and (iii) a piston rod extending from the piston through the non-gas-filled portion to outside the gas-filled and non-gas-filled portions and toward the mass so as to be contacted by the mass moving with a momentum toward the shock absorber, wherein contact of the mass with the piston rod causes movement of the piston and a consequent reduction in volume of the gas-filled portion.

39. A vacuum chamber, comprising:
a vessel having walls collectively defining an interior space of the vacuum chamber;
a movable mass contained within the vacuum chamber; and
a shock-absorber unit for arresting motion of the mass in the vacuum chamber, the shock-absorber unit comprising (i) a contact portion situated and configured to contact the moving mass as the mass moves with a momentum in a movement direction toward the contact portion, (ii) a movement guide situated relative to the contact portion and configured to guide movement of the contact portion as the shock-absorber unit absorbs the momentum of the mass, and (iii) a compliant member situated between the contact portion and a rigid stop and configured to exhibit a compliant deformation, in response to the mass contacting the contact portion, that provides resistance to the motion of the contacting mass.

40. A vacuum chamber, comprising:
a vessel having walls collectively defining an interior space of the vacuum chamber;
a movable mass contained within the vacuum chamber; and
a shock-absorber unit for arresting motion of the mass in the vacuum chamber, the shock-absorber unit comprising a hydraulic cylinder having a housing and a piston rod, the piston rod having a distal end situated and configured to receive an impact of the mass moving in a movement direction, the hydraulic cylinder containing a low-vapor-pressure oil used to arrest the movement of the mass.

41. A microlithography system, comprising:
a vacuum chamber establishing a vacuum environment for performing microlithography;
a movable stage contained within the vacuum chamber; and
a shock-absorber unit for arresting motion of the stage in the vacuum chamber, the shock-absorber unit comprising (i) a shock absorber having a proximal end coupled to a wall of the vacuum chamber and having a distal end extending toward the stage so as to be contacted by the stage moving with a momentum directed toward the shock absorber, the shock absorber being configured to absorb the momentum and thus arrest motion of the stage as the stage, moving toward the shock absorber, makes contact with the distal end; and (ii) isolation means for isolating the shock absorber from the vacuum environment.

42. The microlithography system of claim 41, wherein the stage is a reticle stage or a substrate stage.

43. A microlithography system, comprising:
a vacuum chamber establishing a vacuum environment for performing microlithography;
a movable stage contained within the vacuum chamber; and
a shock-absorber unit coupled to a wall of the vacuum chamber for arresting motion of the stage in the vacuum chamber, the shock-absorber unit comprising (i) a shock absorber including a gas-filled portion, (ii) a piston situated and movable within the gas-filled portion and separating the gas-filled portion from a non-gas-filled portion, and (iii) a piston rod extending from the piston through the non-gas-filled portion to outside the gas-filled and non-gas-filled portions and toward the stage so as to be contacted by the stage moving with a momentum toward the shock absorber, wherein contact of the stage with the piston rod causes movement of the piston and a consequent reduction in volume of the gas-filled portion.

44. The microlithography system of claim 43, wherein the stage is a reticle stage or a substrate stage.

45. A microlithography system, comprising:
a vacuum chamber establishing a vacuum environment for performing microlithography;
a movable stage contained within the vacuum chamber; and
a shock-absorber unit for arresting motion of the stage in the vacuum chamber, the shock-absorber unit comprising (i) a contact portion situated and configured to contact the moving stage as the stage moves with a momentum in a movement direction toward the contact portion, (ii) a movement guide situated relative to the contact portion and configured to guide movement of the contact portion as the shock-absorber unit absorbs the momentum of the stage, and (iii) a compliant member situated between the contact portion and a rigid stop and configured to exhibit a compliant deformation, in response to the stage contacting the contact portion, that provides resistance to the motion of the contacting stage.

46. The microlithography system of claim 45, wherein the stage is a reticle stage or a substrate stage.

47. A microlithography system, comprising:
a vacuum chamber establishing a vacuum environment for performing microlithography;
a movable stage contained within the vacuum chamber; and
a shock-absorber unit for arresting motion of the stage in the vacuum chamber, the shock-absorber unit comprising a hydraulic cylinder having a housing and a piston rod, the piston rod having a distal end situated and configured to receive an impact of the stage moving in a movement direction, the hydraulic cylinder containing a low-vapor-pressure oil used to arrest the movement of the stage.

48. The microlithography system of claim 47, wherein the stage is a reticle stage or a substrate stage.

49. A microlithography system, comprising:
a vacuum chamber establishing a vacuum environment for performing microlithography;
a movable stage contained within the vacuum chamber; and
a shock-absorber unit mounted outside the vacuum chamber and extending into the chamber, the shock-absorber unit being configured to arrest a runaway motion of the stage inside the vacuum chamber.

50. The microlithography system of claim 49, wherein the stage is a reticle stage or a substrate stage.
